(19) United States
(12) Patent Application Publication
(10) Pub. No.: US 2004/0221253 A1
(43) Pub. Date: Nov. 4, 2004

(54) ASIC routability improvement

(76) Inventors: James Imper, Mountain View, CA (US); Floyd D. Kendrick JR., Gilroy, CA (US); Matt Billenstein, Milpitas, CA (US)

Correspondence Address: Sandeep Jaggi, LSI Logic Corporation, Intellectual Property Law Department, 1551 McCarthy Blvd., M/S D-106, Milpitas, CA, 95035, US

(21) Appl. No.: 10/428,262

(22) Filed: Apr. 30, 2003

(51) Int. Cl. G06F 17/50

(52) U.S. Cl. 716/13; 716/12

(57) ABSTRACT

A method and system for improving ASIC routability is disclosed. In a first aspect of the present invention, the method and system include performing an initial cell placement process on an ASIC design; performing a global routing process and creating global routing data, including congestion data; and repeating the initial cell placement process using the congestion data as input, such that cell and routing density in the ASIC design is reduced, thereby reducing routing congestion. In a second aspect of the present invention, the method and system further include performing a placement refinement and buffer insertion process; performing a repeater removal process that uses the congestion data as input and removes buffers from the congested areas; and repeating the placement refinement process, such that global nets are routed around the congested areas.

### FIELD OF THE INVENTION

The present invention relates to ASIC design methodologies, and more particularly to a method for ASIC routability improvement using actual router congestion data to remove sub-optimally placed repeater cells

### BACKGROUND OF THE INVENTION

An application specific integrated circuit (ASIC) is a chip that is custom designed for a specific application, rather than a general-purpose chip such as a microprocessor. An ASIC chip performs an electronic operation as fast as it is possible to do so, providing, of course, that the circuit design is efficiently architected.

FIG. 1 is a block diagram illustrating a basic design flow for fabricating an ASIC. The design flow includes a front-end design process that creates a logical design for the ASIC, and a back-end design process that creates a physical design for the ASIC. The front-end design process begins with providing a design entry 10 for an electronic circuit that is used to generate a high-level electronic circuit description, which is typically written in a Hardware Description Language (HDL) 12.

Interconnect statistical data 14 is used to create a wire load model 16, which defines the resistance, capacitance, and the area of all nets in the design. The statistically generated wire load model 16 is used to estimate the wire lengths in the design and define how net delays are computed. The HDL 12 and the wire load model 16 are then input into a logic synthesis tool 18 to generate a list of logic gates and their interconnections, called a “netlist” 20. Next, system partitioning is performed in step 22 in which the physical design is partitioned to define groupings of cells small enough to be timed accurately with wire load models 16 (local nets). The resulting design typically includes many cells with many interconnect paths. A prelayout simulation is then performed in step 24 with successive refinement to the design entry 10 and to logic synthesis 18 to determine if the design functions properly.

After prelayout simulation 24 is satisfactory, the back-end design process begins with floorplanning in step 26 in which the blocks of the netlist 20 are arranged on the chip. The location of the cells in the blocks are then determined during a placement process in step 28. A routing process makes connections between cells and blocks in step 30. Thereafter, circuit extraction determines the resistance and capacitance of the interconnects in step 32. A postlayout simulation is then performed in step 34 with successive refinement to floorplanning 26 as necessary. Of particular importance to ensuring an efficient ASIC design are the placement and routing processes 28 and 30.

FIG. 2 is a flow chart illustrating the details of a conventional placement and routing processes. The process begins with an initial cell placement process 50 in which cells in the ASIC design are placed and iteratively swapped to minimize the sum of distances between all the cells. A placement refinement and buffer insertion process 52 is then performed that further modifies placement of the cells, makes structural changes to some of the cells, and restructures the cells in order to perform timing closure. The placement refinement and buffer insertion process 52 also inserts buffers and repeaters along long nets to reduce capacitance to further optimize timing. Thereafter, a global routing process 54 is performed that connects cells, wires, layers, and vias based on current process and design rules. Finally, a second placement refinement process 56 is performed after the global routing process 54, which typically changes capacitance estimates and breaks some of the timing closure. Therefore, the placement refinement process 56 is required to perform minor modifications to the design based on the results of the global routing process 54.

Although the placement and routing process described in FIG. 2 will eventually result in a finished ASIC design, the process has several disadvantages. One disadvantage is that the initial cell placement process 50 performs initial placement based on estimates of how the nets will be routed and attempts to reduce routing congestion in the design based on those estimates. The problem is that the estimates rarely ever matches the actual routes generated by the global router 54. Therefore, the reduction in routing congestion performed by the initial placement process 50 is less than optimal.

Another disadvantage has to do with how the placement refinement process 52 performs buffer insertion. As stated above, the placement and refinement process 52 performs timing closure by inserting buffers, repeaters and inverters, along the global nets to reduce crosstalk, among other things, which may result in tens of thousands of buffers. The buffers act as anchors for the global nets and may be placed within highly congested areas of the design. Therefore, when global routing 54 is performed, some global nets will be routed through the congested areas due to buffer insertion. The effect is that routability decreases and congestion increases in ASIC design.

A further disadvantage is that any point during this process, the ASIC designer must manually review the results of each process and rerun one or more of the processes should the results be inadequate. For deep submicron designs, many such iterative loops may be required to obtain timing closure. The additional loops can add days or weeks to a project schedule and significantly increase the cost of the design.

Accordingly, what is needed is an improved method for reducing routing congestion in ASIC designs. The present invention addresses such a need.

### SUMMARY OF THE INVENTION

The present invention provides a method and system for improving ASIC routability. In a first aspect of the present invention, the method and system include performing an initial cell placement process on an ASIC design; performing a global routing process and creating global routing data, including congestion data; and repeating the initial cell placement process using the congestion data as input, such that cell and routing density in the ASIC design is reduced, thereby reducing routing congestion. In a second aspect of the present invention, the method and system further include performing a placement refinement and buffer insertion process; performing a repeater removal process that uses the congestion data as input and removes buffers from the congested areas; and repeating the placement refinement process, such that global nets are routed around the congested areas.

According to the system and method disclosed herein, the present invention reduces ASIC routing congestion by using actual router congestion data as input to the initial cell placement process, as well as to remove sub-optimally placed buffer cells that were inserted into congested areas of the design by the placement and refinement process.

### BRIEF DESCRIPTION OF THE DRAWINGS

FIG. 1 is a block diagram illustrating a conventional design flow for fabricating an ASIC.

FIG. 2 is a flow chart illustrating the details of a conventional placement and routing processes.

FIG. 3 is a flow chart illustrating the details of the process for reducing routing congestion in ASIC design in accordance with a preferred embodiment of the present invention.

FIGS. 4 and 5 are diagrams illustrating example views of global nets generated by the global routing process.

FIG. 6 is a flow chart illustrating the congestion map generation process in accordance with the first aspect of the present invention.

FIG. 7 is a diagram illustrating how overflow data is represented by tile regions.

FIG. 8 is a flow chart illustrating the details of the buffer and repeater removal process in accordance with the second aspect of the present invention.

### DETAILED DESCRIPTION

The present invention relates to methods for reducing routing congestion in ASIC designs. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for reducing ASIC routing congestion. The method and system reduce ASIC routing congestion by using actual router congestion data as input to the initial cell placement process as well as to remove sub-optimally placed buffer cells that were inserted into congested areas of the design by the placement and refinement process.

In a first aspect of the present invention, routing congestion is reduced by inputting actual congestion data to the initial cell placement process 50 to allow the initial cell placement 50 to more effectively reduce cell and routing density, which in turn, reduces routing congestion. More particularly, an additional global routing step is performed and the actual congestion data generated by global routing step is fed back into the initial cell placement 50. This allows the initial cell placement 50 to minimize congestion in the design prior to performing placement refinement and buffer insertion 52, whose results rely heavily on the initial cell placement.

In a second aspect of the present invention, the actual congestion data is used to further reduce routing congestion by performing a repeater removal process on the ASIC design after the global routing process 54. Using the actual congestion data, the repeater removal process is able to identify congested areas of the design and remove the buffers (which includes repeaters and inverters) inserted into those areas by the placement refinement 52. The global routing process 54 is then run again, such that global nets are routed around the congested areas because the buffers and those areas that anchor the global nets have been removed.

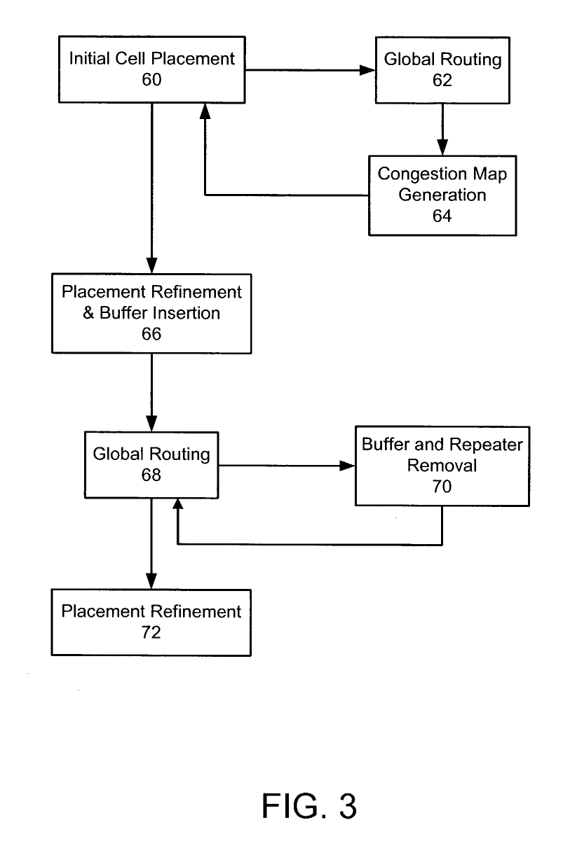

FIG. 3 is a flow chart illustrating the details of the process for reducing routing congestion in ASIC design in accordance with a preferred embodiment of the present invention. The process begins with an initial cell placement process 60 in which cells in the ASIC design are placed and iteratively swapped to minimize the sum of distances between all the cells. According to the first aspect of the present invention, a global routing process 62 is performed that connects cells, wires, layers, and vias based on current process and design rules. A congestion map generation process 64 generates a congestion map from the global routing data and inputs the congestion map to the initial cell placement process 60. Initial cell placement process 60 is then run again using actual congestion data, which results in improved routing congestion reduction.

After the initial cell placement generation, a placement refinement process and buffer insertion 66 is performed that further modifies the placement of the cells, makes structural changes to some of the cells, and restructures the cells in order to perform timing closure. The placement refinement and buffer insertion process 66 also inserts buffers along long nets to reduce capacitance to further optimize timing. Thereafter, a global routing process 68 is performed.

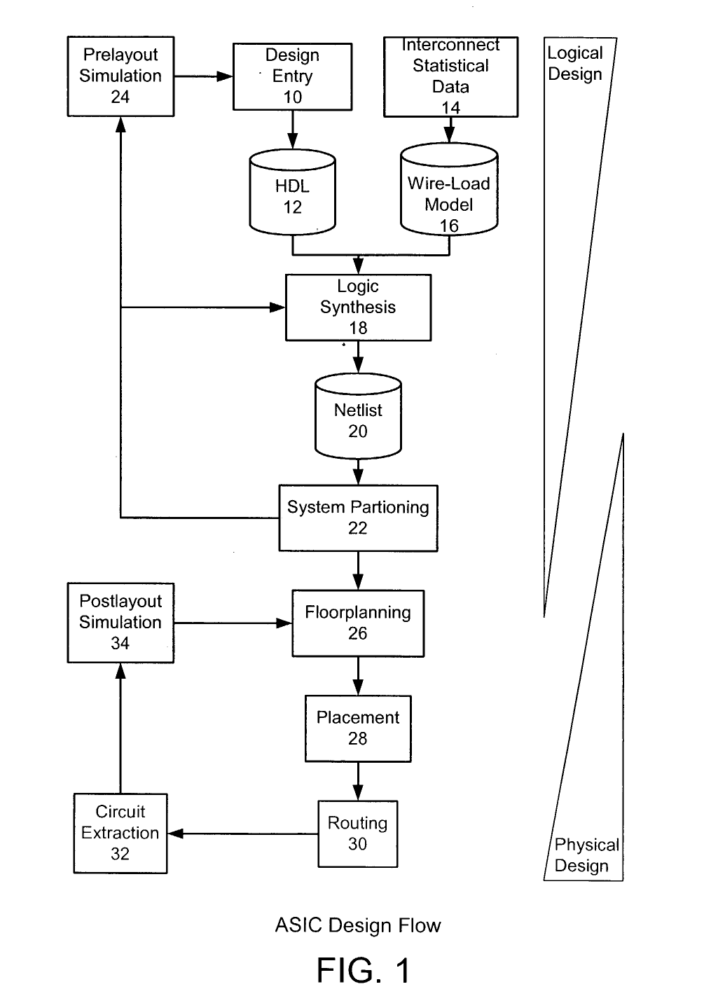

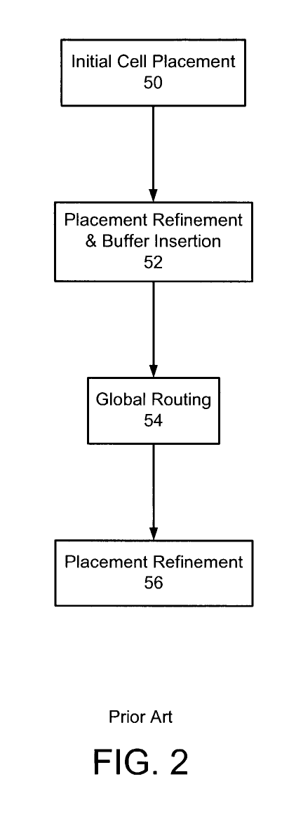

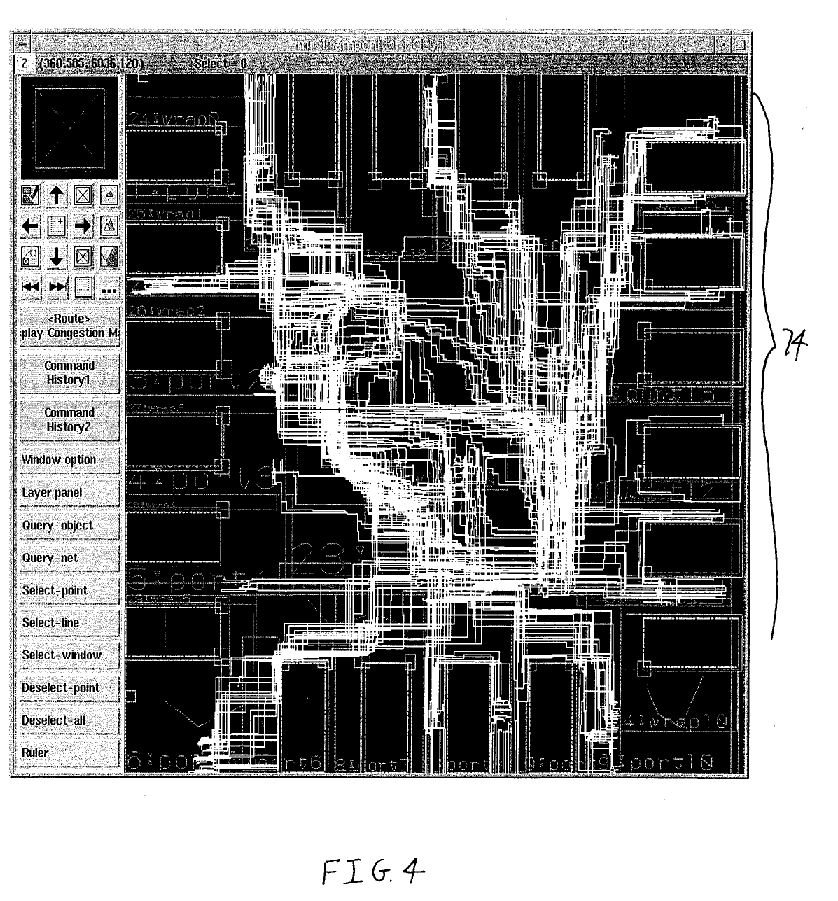

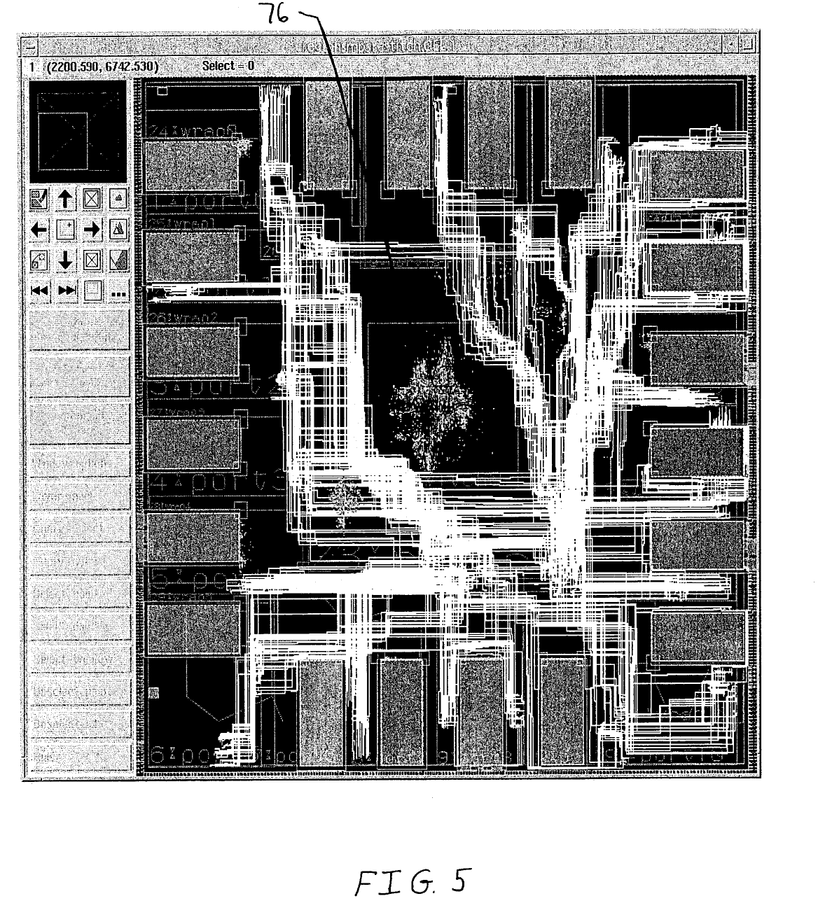

FIGS. 4 and 5 are diagrams illustrating example views of global nets generated by the global routing processes 62 and 68. FIG. 4 illustrates global nets 74 generated by the global routing process 68 after buffer insertion. Assume that in the design shown, an area of routing congestion 76 occupies the center of the diagram, as shown in FIG. 5. The placement refinement and buffer insertion process 66 places buffers, inverters, and repeaters (not shown) in the design along paths directly between pairs of cells, which results in buffers, inverters, and repeaters being sub-optimally located through the congested area. Referring to FIG. 1, because the buffers and repeaters anchor the global nets, some global nets are routed through the congested area (center of the diagram), increasing routing congestion.

According to a second aspect of the present invention, routing congestion is further reduced by performing a repeater removal process 70 that identifies congested areas of the design and removes the buffers inserted into those areas by the placement refinement and buffer insertion process 52. The global routing process 68 is then run again.

FIG. 5 illustrates the global nets 74 generated by the second run of global routing process 68 after buffer, inverter, and repeater removal. Because the buffers, inverters, and repeaters were removed from the congested areas 76, the resulting global nets 74 are routed around the congested area 76 in the center of the diagram, which minimizes routing congestion.

Referring again to FIG. 3, the routing congestion reduction process ends with a second placement refinement process 72 that performs minor modifications to the design based on the changes made by the global routing process 68.

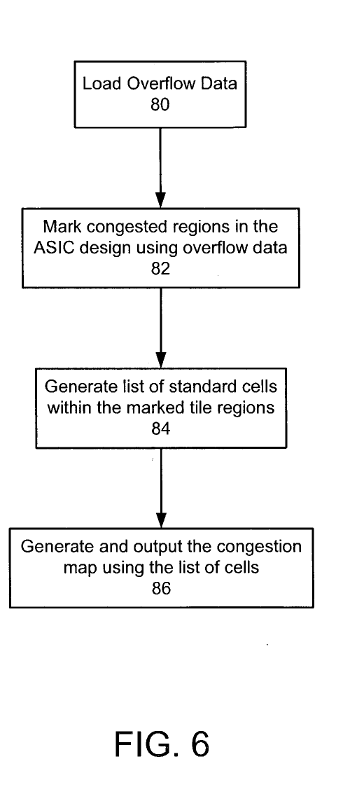

FIG. 6 is a flow chart illustrating the congestion map generation process 64 of FIG. 3 in accordance with the first aspect of the present invention. In a preferred embodiment, the process includes four main functions that begin with loading overflow data in step 80. The global routing process 62 generates a text (ASCII) file that contains the overflow data for each global route cell, for both horizontal and vertical routing resources. The overflow data includes an overflow number for each global route cell in the design. A global route cell (GRC) is a square with sides equal to the height of a standard cell placement row. The overflow number for each GRC is calculated by subtracting the available routing resources for all available routing layers from the required routing resources. For example, if the number of wires needed to pass through a GRC is greater than the number of available routing tracks, then a positive overflow number is generated for the GRC. Higher overflow numbers indicate areas of routing congestion. The overflow data for the ASIC design may be loaded into an internal data dictionary for future processing.

In step 82, the overflow data is used to mark congested regions in the ASIC design for the purposes of identifying areas of congestion on a scale that is much larger then the unit GRC size. In a preferred embodiment, the ASIC routing area is broken up into tile regions, each of which may contain on the order of 10000 GRCs. However, the tile size is preferably user-defined. This tile selection process causes the areas of congestion to be algorithmically selected based on user specified thresholds and limits.

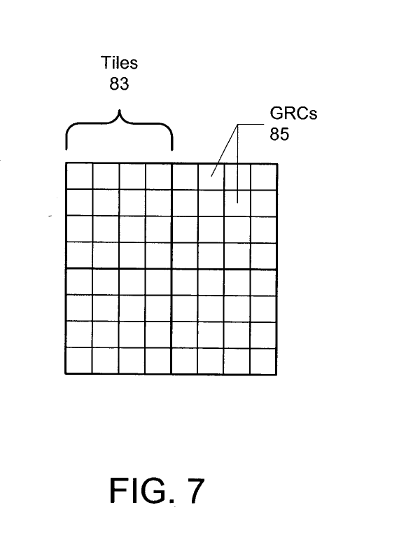

FIG. 7 is a diagram illustrating how overflow data is represented by tile regions 83. The mark tiles process calculates the number of overflowing GRCs 85 within each tile 83. If the percentage of overflowing GRCs 85 within a tile region 83 exceeds the user-defined threshold, then the tile region 83 is marked as congested.

Referring again to FIG. 6, after the congested tile regions 83 are marked, a list of standard cells within the marked tile regions 83 is generated in step 84. This process employs a hash table search algorithm to create the cell list. The cell list preferably includes each standard cell that is 50% or more enclosed by the regions represented by a union of the tiles 83.

The final process is to use the list of cells to generate and output the congestion map in step 86. In a preferred embodiment, the congestion map is implemented as an increased cell height file that contains the cell list and a cell height multiplier that is provided by the user based on design characteristics. When the congestion map is subsequently read by the placement refinement process 66, the placement refinement process 66 will use the cell height multiplier to increase the cell heights of the cells identified in the cell list and redistribute placement of the enlarged cells. According to this aspect of the present invention, cell redistribution bases on actual congestion data from the global router 62 results in a reduction in congestion, and hence an increase in routability.

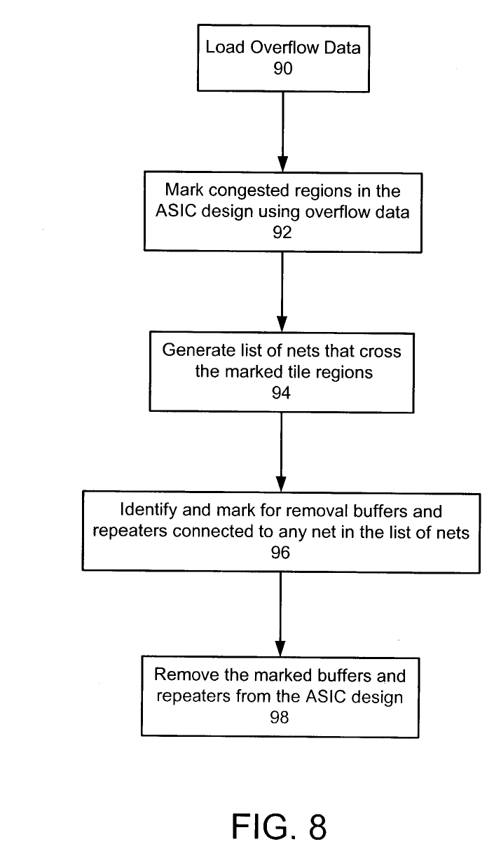

FIG. 8 is a flow chart illustrating the details of the buffer and repeater removal process 70 of FIG. 3, in accordance with the second aspect of the present invention. The process begins as described above with loading overflow data in step 90 and marking the congested tile regions in step 92. In step 94, a list of nets that cross the marked tile regions is generated. In step 96, the buffers, inverters, and repeaters connected to any of the nets in the list of nets are identified and marked for removal. And in step 98, the marked buffers, inverters, and repeaters are removed from the ASIC design. By using actual routing data to perform a buffer rip-up and rerouting the global nets around congestion regions, the second aspect of the present invention further minimizes congestion.

A method and system for reducing routing congestion in ASIC designs has been disclosed. The present invention has been described in accordance with the embodiments shown, and one of ordinary skill in the art will readily recognize that there could be variations to the embodiments, and any variations would be within the spirit and scope of the present invention. In addition, software written according to the present invention may be stored on a computer-readable medium, such as a removable memory, or transmitted over a network, and loaded into a computer for execution. Accordingly, many modifications may be made by one of ordinary skill in the art without departing from the spirit and scope of the appended claims.

What is claimed is:

1 A method for improving ASIC routability, the method comprising the steps of:
(a) performing an initial cell placement process on an ASIC design;
(b) performing a global routing process and creating global routing data, including congestion data; and
(c) repeating the initial cell placement process using the congestion data as input, such that cell and routing density in the ASIC design is reduced, thereby reducing routing congestion.

2 The method of claim 1 further including the steps of: generating a congestion map from the global routing data, and inputting the congestion map to the initial cell placement process.

3 The method of claim 1 further including the step of:
(d) performing a placement refinement and buffer insertion process;
(e) performing a repeater removal process that uses the congestion data as input and removes buffers from the congested areas; and
(f) repeating the placement refinement process, such that global nets are routed around the congested areas.

4 The method of claim 2 wherein step (b) further including the steps of:
(i) loading overflow data;
(ii) using the overflow data to mark congested regions in the ASIC design;
(iii) generating a list of standard cells within by the congested regions; and
(iv) outputting the congestion map as an increased cell height file that contains the cell list and a cell height multiplier.

5 The method of claim 4 wherein step (b)(i) further includes the step of: including an overflow number in the overflow data for each global route cell (GRC) in the design.

6 The method of claim 4 wherein step (b)(ii) further includes the step of: breaking the ASIC design into tile regions, each of which contains a user-defined number GRCs.

7 The method of claim 6 wherein step (b)(ii) further includes the steps of: calculating the number of overflowing GRCs within each tile, and if a percentage of overflowing GRCs within a tile region exceeds a user-defined threshold, then marking the tile region as congested.

8 The method of claim 4 wherein step (b)(iii) further includes the step of: including in the cell list each standard cell that is 50% or more enclosed by a union of the tile regions.

9 The method of claim 3 wherein step (e) further including the steps of:
(i) loading overflow data;
(ii) marking the congested tile regions;
(iii) generating a list of nets that cross the marked tile regions;
(iv) identifying buffers connected to any of the nets in the list of nets and marking the buffers for removal; and
(v) removing the marked buffers from the ASIC design.

10 A method for improving ASIC routability, the method comprising the steps of:
(a) performing an initial cell placement process on an ASIC design;
(b) performing a global routing process and creating global routing data, including congestion data;
(c) performing a placement refinement and buffer insertion process;
(d) performing a repeater removal process that uses the congestion data as input and removes buffers from the congested areas; and
(e) repeating the placement refinement process, such that global nets are routed around the congested areas.

11 The method of claim 10 wherein step (d) further including the steps of:
(i) loading overflow data;
(ii) marking the congested tile regions;
(iii) generating a list of nets that cross the marked tile regions;
(iv) identifying buffers connected to any of the nets in the list of nets and marking the buffers for removal; and
(v) removing the marked buffers from the ASIC design.

12 The method of claim 10 further including the step of:
(f) generating a congestion map from the congestion data prior to performing step (c), and inputting the congestion map to the initial placement process and repeating step (a), such that cell and routing density in the ASIC design is reduced, thereby reducing routing congestion.

13 The method of claim 12 wherein step (f) further including the steps of:
(i) loading overflow data;
(ii) using the overflow data to mark congested regions in the ASIC design;
(iii) generating a list of standard cells within by the congested regions; and
(iv) outputting a congestion map as an increased cell height file that contains the cell list and a cell height multiplier.

14 The method of claim 13 wherein step (f)(i) further includes the step of: including an overflow number in the overflow data for each global route cell (GRC) in the design.

15 The method of claim 13 wherein step (f)(ii) further includes the step of: breaking the ASIC design into tile regions, each of which contains a user-defined number GRCs.

16 The method of claim 15 wherein step (f)(ii) further includes the steps of: calculating the number of overflowing GRCs within each tile, and if a percentage of overflowing GRCs within a tile region exceeds a user-defined threshold, then marking the tile region as congested.

17 The method of claim 13 wherein step (f)(iii) further includes the step of: including in the cell list each standard cell that is 50% or more enclosed by a union of the tile regions.
